(19) United States
(12) Patent Application Publication
(10) Pub. No.: US 2018/0164232 A1
(43) Pub. Date: Jun. 14, 2018

(54) TOMOGRAPHIC IMAGE-CAPTURING TECHNIQUE

(71) Applicant: GEORG-AUGUST-UNIVERSITAET GOETTINGEN STIFTUNG OEFFENTLICHEN RECHTS, Goettingen (DE)

(72) Inventors: Tim SALDITT, Goettingen (DE); Malte VASSHOLZ, Goettingen (DE); Benno KOBERSTEIN-SCHWARZ, Aalen (DE)

(73) Assignee: GEORG-AUGUST-UNIVERSITAET GOETTINGEN STIFTUNG OEFFENTLICHEN RECHTS, Goettingen (DE)

(21) Appl. No.: 15/577,249

(22) PCT Filed: Aug. 10, 2016
(86) PCT No.: PCT/EP2016/069071

§ 371 Date: Nov. 27, 2017

(30) Foreign Application Priority Data
Aug. 11, 2015 (DE) 10 2015 215 323.1

(51) Int. Cl. G01N 23/046

(52) U.S. Cl. CPC G01N 23/046; G01N 2223/419; G01N 2223/309

(57) ABSTRACT

A tomographic image-capturing technique is described. According to one device aspect (100) of the technique, a radiation source (102) is embodied to emit a beam. The radiation source (102) has a first transverse dimension (108) across the beam and a second transverse dimension (110) substantially perpendicular to the first transverse dimension (108). The second transverse dimension (110) is larger than the first transverse dimension (108). A detector (106) is embodied to capture the beam. A sample holder (104) arranged between radiation source (102) and detector (106) is embodied to rotate a sample in the beam about a first axis (112) and about a second axis (114) which differs from the first axis (112).

### TECHNICAL FIELD

A tomographic image-capturing technique is described. In particular, without being restricted thereto, a device and a method for tomography by means of an anisotropic radiation source are described.

### PRIOR ART

In conventional computed tomography (CT), an X-ray of defined geometry, for example a collimated beam or a cone beam, is pointed through a sample at a detector. In analytical CT in particular, a cone beam is used, which emanates from as point-shaped a source as possible, in order to achieve a geometrical enlargement of the object or sufficient (partial) coherence for generating phase contrast. The measured intensity is the line integral of the attenuation of the beam within the sample due to absorption and scatter. If the beam is collimated, for example, in the x- and y-direction and propagates in the z-direction, the detected signal contains no information about where structure-forming absorption or scatter centres are positioned in the z-direction.

For an angular position the detector detects a projection, i.e. a line integral as a function of y for a tomographic cross-sectional image and if applicable also as a function of x for a spatial tomography image. By rotating source and detector or the sample about the x-axis perpendicular to the propagation direction, a plurality of such projections is detected. The tomography image can be determined from the individual line integrals for the various angular positions and their displacement in the y-direction by inversion of the Radon transform.

Conventional CT has the disadvantage that the linear expansion of the radiation source limits the resolution of the tomography image. For many applications, therefore, the highly collimated or focused beams of a synchrotron source are necessary. However, the use of a synchrotron source is associated with a considerable maintenance outlay and obstructs the flexible use of CT in terms of time and location.

For the use of radiation sources on the scale of a testing laboratory or medical practice, the focal spot of the radiation source, for example an X-ray tube, must be made smaller by collimators at the expense of the source fluence. A more effective utilisation the source fluence or the partial coherence would permit tomographic image capturing with more compact and/or more cost-effective radiation sources.

### SUMMARY

A possible object of the present invention is thus to provide a technique for tomographic image capturing that permits more effective utilisation of the source fluence.

According to one aspect, a device for tomographic image capturing is provided for this. The device comprises a radiation source, which is embodied to emit a beam, wherein the radiation source has a first transverse dimension across the beam and a second transverse dimension substantially perpendicular to the first transverse dimension, wherein the second transverse dimension is greater than the first transverse dimension; a detector, which is embodied to detect the beam; and a sample holder arranged between radiation source and detector that is embodied to rotate a sample in the beam about a first axis and about a second axis which differs from the first axis.

Exemplary embodiments of the device can utilise the source fluence and/or another anisotropic property of the radiation source more effectively for tomographic image capturing.

The beam can be detected in the transmission direction. The detector can be embodied to detect an intensity of the beam.

The first and/or the second transverse dimension can be determined by a property of the radiation source and/or of the beam. For example, the first and/or the second transverse dimension can be determined by an expansion, a focal spot, a collimation, an aperture, coherence and/or polarisation of the radiation source.

The term “radiation source” can refer to the totality of the locations from which the beam emanates. The expansion of the radiation source can refer to the expansion of an area on the radiation source from which the beam emanates. The second transverse dimension can be the maximum distance between locations from which the beam emanates.

The second transverse dimension can be more than twice as great as the first transverse dimension. For example (at least viewed opposite to the propagation direction of the beam), the totality of the locations from which the beam emanates can be a slot.

Any anisotropic radiation source can be used as a radiation source. An anisotropic radiation source can preferably be arranged, for example by rotational orientation, so that a minimal expansion of the radiation source forms the first transverse dimension and/or a maximal expansion of the radiation source forms the second transverse dimension.

Alternatively or in addition, the detector can be anisotropic, for example the resolution of the detector can be anisotropic. The resolution in the first transverse dimension can be higher (i.e. finer) than in the second transverse dimension. For example, pixels of the detector can be respectively anisotropic. The detector can be arranged so that a minimal expansion of the pixel coincides with the first transverse dimension and/or that a maximal expansion of the pixel coincides with the second transverse dimension.

In a first variant, the radiation source is anisotropic according to the first transverse dimension, which is smaller than the second transverse dimension, and the detector resolves in the direction of the first transverse dimension and in the direction of the second transverse dimension. In the first variant, the propagation direction of the beam and the second transverse dimension define the planes of the three-dimensional Radon transform. In a second variant, the radiation source is substantially isotropic and the detector is anisotropic with a first resolution in a first directions transversely to the propagation direction of the beam and a second resolution in a second direction transversely to the propagation direction of the beam, wherein the first direction is perpendicular to the second direction, and the first resolution is higher (i.e. finer) than the second resolution. In the second variant, the propagation direction of the beam and the second direction define the planes of the three-dimensional Radon transform. Furthermore, the first and second variant can be combined, for example in that the radiation source is anisotropic according to the first transverse dimension, which is smaller than the second transverse dimension, and the detector is anisotropic with a first resolution in the direction of the first transverse dimension and a second resolution in the direction of the second transverse dimension, wherein the first resolution is higher (i.e. finer) than the second resolution.

In all three cases the evaluation can be based on an inversion of the three-dimensional Radon transform. Alternatively, known numerical reconstruction methods can be adapted for the evaluation of the dataset.

The term “beam” can describe a general propagation direction and/or a main propagation direction of radiation. For example, the radiation, at least in the region of the sample holder, can be capable of representation approximately by one or more plane waves. The term “beam” can describe the propagation direction of the plane wave or a common propagation direction of the multiple plane waves.

The first axis can be substantially perpendicular to the second axis. The first axis can (for example, during the overall tomographic image capturing) be substantially parallel to the beam. The second axis can (for example, during the overall tomographic image capturing) be substantially perpendicular to the beam.

The sample holder or the sample can also be rotated in the beam about more than two axes.

The rotation of the sample or of the sample holder in the beam can be realised as a rotation of the sample or of the sample holder relative to the beam. In particular, the beam can be rotated about the axes, for example by a corresponding rotation of the radiation source (and if applicable of the detector also). Alternatively the radiation source (and if applicable also the detector) can be fixed during the image capturing and the sample or the sample holder rotated. Furthermore, a combined rotation of sample or sample holder and beam is possible. For example, the radiation source and/or the detector can be rotated about the first axis, and the sample holder can be rotated about the second axis, or vice versa.

The device can further comprise a controller. The controller can coordinate the rotation about the first and second axis. The controller can be embodied to rotate the sample by means of the sample holder jointly about the first axis and the second axis for a (for example, for respectively one) tomographic image capture. The joint rotation can be realised by a simultaneous or alternating rotation about the two axes.

Advantageously the first axis and/or the second axis does not coincide during the overall tomographic image capturing or several recordings with the direction of the second transverse dimension.

The joint rotation can be realised, for example, in that the sample or the sample holder rotates about the second axis while the second axis tilts about the first axis. The sample or the sample holder can rotate repeatedly about the second axis while the second axis tilts about the first axis.

The tilting about the first axis can be less than a complete revolution. For example, the second axis can tilt by substantially 90° about the first axis. The second axis can be parallel to the first transverse dimension at the start of the tomographic image capturing, and the second axis can be parallel to the second transverse dimension at the end of the tomographic image capturing, or vice versa.

The controller can be embodied to detect the beam (for example, its intensity and/or its phase displacement) by means of the detector in a plurality of rotational positions for the tomographic image capturing. Each rotational position can correspond to a point on a sphere or hemisphere. Alternatively or in addition, each of the rotational positions can be determined by a combination of a rotation angle ϑ about the first axis and a rotation angle ϕ about the second axis. The plurality of rotational positions can be distributed uniformly on the sphere or hemisphere, for example with regard to a surface area of the sphere or hemisphere. A linear connection can exist between the angle ϕ and the cosine of the angle ϑ for the plurality of rotational positions.

The detector and/or an evaluation unit connected to the detector can be embodied to detect the beam in the direction of the second transverse dimension unresolved or with low resolution (e.g. with a lower resolution than in the direction of the first transverse dimension). The unresolved detection in the direction of the second transverse dimension can at least approximately realise a plane integral. For example, a detector signal can be added up in the direction of the second transverse dimension.

Alternatively or in addition, the detector and/or an evaluation unit connected to the detector can be embodied to detect the beam resolved in the direction of the first transverse dimension. The direction of the first transverse dimension can realise a linear displacement of a three-dimensional Radon transform.

Distances of the device can be selected so that a diameter of the sample or of a volume of the sample holder is small compared with the distance between radiation source and detector. A linear dimension of the sample holder or of a sample that can be taken up in the sample holder can be a fraction of a distance between radiation source and sample and/or of a distance between detector and sample.

The beam emitted can comprise electromagnetic radiation. The beam emitted can comprise (for example, soft or hard) X-ray radiation.

The measured intensity can be a transmission intensity. The measured intensity can be a measure of absorption and/or scatter. The detector can further be embodied to detect a phase of the beam and/or an evaluation unit connected to the detector can be embodied to reconstruct a phase of the beam. The detector can detect a phase contrast and/or a coherence contrast.

All the plane integrals necessary for a retransformation (inversion) of the three-dimensional Radon transform (e.g., families of parallel planes with normal vectors on the unit sphere) can be realised by the joint rotations about more than one axis. To this end the rotational positions can run through a sampling scheme preprogrammed in the controller.

The evaluation unit can further be embodied to invert a three-dimensional Radon transform (reconstruction). Archetype planes of the three-dimensional Radon transform can be substantially parallel. The family of the parallel archetype planes can determine a common normal vector of the Radon transform. The normal vector can correspond to the rotational position. The archetype planes can, for example, be parallel to the second transverse dimension and/or to the beam.

The measured intensity can be converted into one or more cross-sectional images (two-dimensional images with pixels) or a spatial graphic (three-dimensional image with voxels). The conversion can be computer-implemented. The technique can be ascribed to computed tomography.

The tomographic intensity detection and/or the spatial reconstruction of an object can be based on two-dimensional sampling of rotational positions, i.e. sampling with two (or more) rotational degrees of freedom. The at least two rotational degrees of freedom can comprise rotational positions with regard to a pivot point. The rotational positions can be parameterised according to the two rotational degrees of freedom, for example by means of two rotation angles. The at least two rotation angles can comprise the second and the third Euler angle.

The reconstruction can be based on a three-dimensional Radon transform (3dRT) or its inversion. The beam configuration can be anisotropic due to the larger second transverse dimension. The radiation source can be extended in at least the direction of the second transverse dimension, which is not parallel to the beam direction. The direction of the second transverse dimension can at least be substantially perpendicular to the beam direction. In spite of the anisotropic beam configuration, for example independently of the expansion of the beam configuration in the direction of the second transverse dimension, a spatial resolution of the tomographic image capture (at least with reference to the pivot point) can be isotropic.

The beam direction and the direction of the second transverse dimension (e.g. the expanded direction of the radiation source) can define the family of parallel planes.

An integral signal (e.g. the measured intensity) can be detected respectively for each of the planes. A data value of the integral signal can correspond to a plane in each case. The spatial resolution of the tomographic image capture can be determined by the first transverse dimension and/or a resolution perpendicular to the planes.

A one-dimensional dataset (e.g. a data row of the data values) of the integral signal can be detected for each rotational position. The dataset can be parameterised by the planes, for example by means of an index of the planes. A family of parallel planes can correspond to each rotational position. The family of the parallel planes can be parameterised according to the (at least) two rotational degrees of freedom.

A complete dataset for the tomographic image capture can be parameterised by three indices. The complete dataset can be parameterised by the plane index and the two rotation angles.

The use of a radiation source expanded in one dimension can have a higher particle current density, for example in comparison to a substantially point-shaped radiation source and/or a radiation source with collimator. By integration over the respective plane a desired fluence and/or a desired ratio of signal to noise can be detected in a shorter time for each rotational position.

Due to the expanded radiation source, a more compact and/or cost-effective radiation source can be used, for example without restricting the fluence of the radiation source, for instance by collimators. Synchrotron radiation can be dispensed with due to the use of the expanded radiation source. A more compact device and/or more cost-effective tomography are thereby made possible. The radiation source can comprise an X-ray tube, for example. The radiation can be generated by bremsstrahlung. According to another aspect, a method for tomographic image capturing is provided. The method comprises the emission of a beam emanating from a radiation source, which has a first transverse dimension across the beam and a second transverse dimension substantially perpendicular to the first transverse dimension, wherein the second transverse dimension is greater than the first transverse dimension; detection of the beam by means of a detector; and the rotation of a sample in the beam by means of a sample holder arranged between radiation source and detector about a first axis and about a second axis which differs from the first axis.

The method can further comprise any feature of the device aspect, or a corresponding method step.

### BRIEF DESCRIPTION OF THE DRAWINGS

Further features of the technique are described below on the basis of exemplary embodiments with reference to the enclosed drawings, wherein:

FIG. 1 shows schematically a first exemplary embodiment of a device for tomographic image capturing;

FIG. 2 shows schematically a second exemplary embodiment of a device for tomographic image capturing;

FIG. 3 (a) shows schematically a third exemplary embodiment of a device for tomographic image capturing;

FIG. 3 (b) shows schematically a first exemplary embodiment for determining a plane integral;

FIG. 3 (c) shows schematically a second exemplary embodiment for determining a plane integral; and

FIG. 4 shows a scheme for sampling the rotational positions in the reference system of the sample.

### DETAILED DESCRIPTION

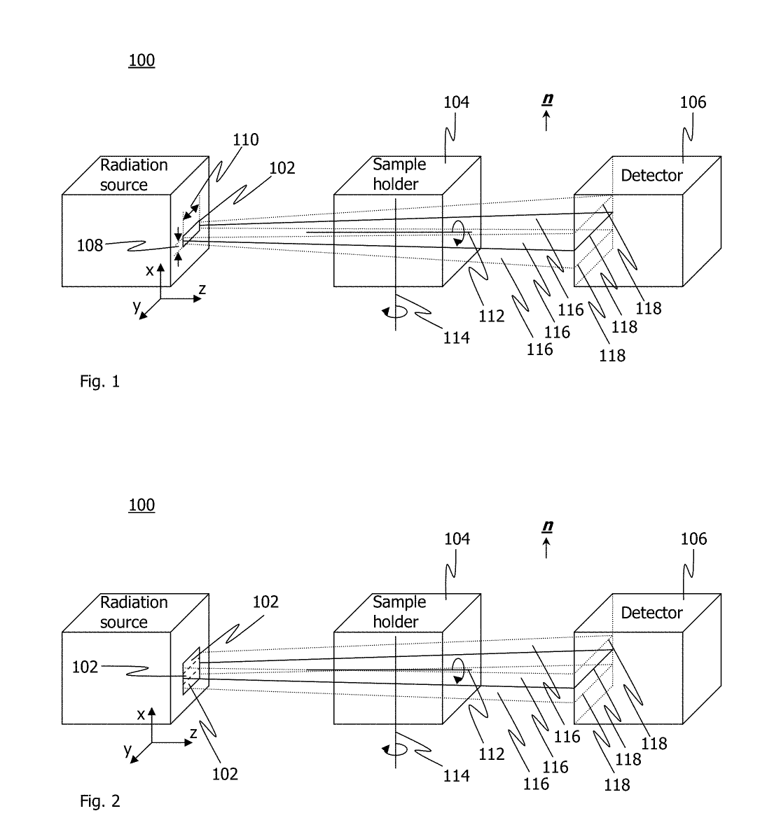

FIG. 1 shows a first exemplary embodiment of a device designated generally by reference sign 100 for tomographic image capturing. The device 100 comprises a radiation source 102, a sample holder 104 and a detector 106. The radiation source 102 emits a beam, which is capable of at least partially shining through a sample taken up in the sample holder 104 and is detected by the detector 106.

The beam can comprise electromagnetic radiation (for example X-ray radiation), electron radiation, neutron radiation or ion radiation.

The radiation source 102 is anisotropic. The beam emanating from the radiation source 102 has a first transverse dimension 108 and a second transverse dimension 110. The first transverse dimension 108 is smaller than the second transverse dimension 110.

The first transverse dimension and the second transverse dimension are each perpendicular to a main propagation direction of the beam, for example perpendicular to a connecting line between radiation source 102 and detector 106. The main propagation direction is designated by the coordinate z in FIG. 1. The transverse dimensions 108 and 110 can lie in a wave front plane of the beam.

The first transverse dimension 108 and the second transverse dimension 110 are perpendicular to one another. In the coordinate system in FIG. 1 the first transverse dimension 108 extends in direction x and the second transverse dimension 110 extends in direction y.

The sample holder is capable of rotating the sample in the beam about a first axis 112 and about a second axis 114. In a first variant, the sample holder 104 is arranged between radiation source 102 and detector 106, for example without being connected to radiation source 102 and detector 106. In a second variant, the sample holder 104 is connected to the radiation source 102 and the detector 106 in such a way that the radiation source 102 and the detector 106 are rotated about the sample. The description includes both variants, wherein the xyz-coordinate system is determined by the first transverse dimension 108, the second transverse dimension 110 and the main propagation direction (or an optical axis).

The beam arriving at the detector 106 is modulated by the object taken up in the sample holder 104, for example in respect of intensity (or amplitude), phase and/or polarisation. The detector 106 detects the modulated beam one-dimensionally resolved solved. The direction of the resolution is described below by a vector n. The vector n is shown in the figures by way of example.

The normal vector n is determined by the radiation source 102. The normal vector n of the three-dimensional Radon transform is perpendicular to the propagation direction of the beam and perpendicular to the second transverse dimension 110. The normal vector n is the basis for a three-dimensional Radon transform.

The detector 106 detects at least one signal S for each plane 116 of the beam. The family of detected planes 116 is respectively perpendicular to the vector n. The vector n is (at least approximately) the common normal vector of the detected planes 116.

An (optionally discretised) coordinate in the direction of the normal vector n is described by sin the following. The coordinate s can correspond to the coordinate x or be a linear function of the same. The coordinate s in the direction of the normal vector n can also be described as a displacement.

For example, the planes 116 in the sample holder 104 and/or at the detector 106 (on the lines respectively designated by reference sign 118) can be spaced respectively from one another by h, so that the j-th plane 116 comprises the points x=(x,y,z)^{T} with

s=x·n=j·h

and is determined by an integer plane index j:

The one-dimensionally resolved signal detected in a rotational position of the sample or the sample holder 104 is the basis of a dataset S(s). The dataset S(s) can be formed directly from the signals detected for the individual planes (for example in the case of a substantially simultaneous recording) or by post-processing (for example normalising or averaging several recordings in the same rotational position).

The detector 106 can be restricted to a one-dimensional resolution, for example by a suitable arrangement of pixels. The pixels can be anisotropic. For example, the pixels can be expanded respectively in a detector plane in the direction of the second transverse dimension 110 and/or perpendicular to the normal vector n (for example along the lines 118 respectively).

If a higher-dimensionally resolving detector 106 (for example, a two-dimensionally resolving detector also suitable for conventional tomography) is used, its signal can be summed along the lines 118 respectively.

FIG. 2 shows a second exemplary embodiment of the device 100. Identical reference signs designate features that correspond to those of the first exemplary embodiment or match those. The radiation source 102 is not necessarily anisotropic in respect of its expansion. A wave vector k of the beam can be substantially uniform or collimated along the second transverse dimension 110. Along the first transverse dimension 108 the wave vector can be uneven, for example divergent or uncorrelated.

Alternatively or in addition, the first transverse dimension 108 and the second transverse dimension 110 can each be defined as a correlation length of a radiation property. The radiation property can relate to a polarisation and/or a coherence of the beam.

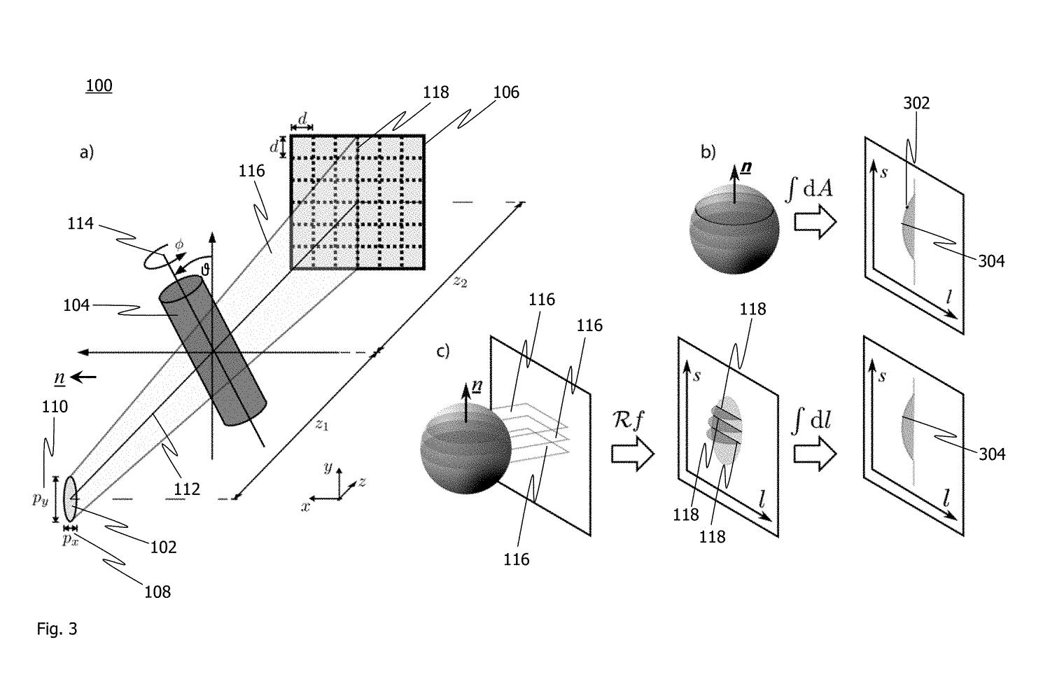

FIG. 3 (a) shows a third exemplary embodiment of the device 100. An expansion pₓ of the radiation source 102 is smaller according to the first transverse dimension 108 than an expansion p_{y} of the radiation source 102 according to the second transverse dimension 110.

In a first implementation, the detector 106 resolves in the direction of the normal vector n (recorded by the detector coordinate 5) and perpendicular to it (recorded by the detector coordinate l). As shown schematically in FIG. 3 (c), the detected signal S(s,l) is a projection R′ in direction z due to the image, for example a sum along the direction z with regard to material density, absorption and/or phase displacement in the sample. By numerical integration in the direction of the second transverse dimension 110 along the lines 118, the signal S(s) described by the reference sign 304, or contributions to it, is obtained.

In a second implementation, the detector 106 resolves exclusively in the direction of the normal vector n. This is shown schematically in FIG. 3 (b). The single signal S(s) described by the reference sign 302, or individual contributions to it, can thereby be directly obtained for a displacement s A curve of the signal S as a function of the displacement s is shown by the reference sign 304.

Through both implementations a plane integral, Rf, of a property, ƒ(x), of the sample can be detected at least approximately in the result. The plane integral [Rₙƒ](s) of the property ƒ(x) extends in this case over the sectional plane with the sample, which plane is determined by the normal vector n and the displacement s. The sample is shown by way of example as a sphere in FIGS. 3 (b) and 3 (c). The sample can have any external shape and any inner inhomogeneity to detect it tomographically.

Each rotational position can be represented according to the (at least) two rotational degrees of freedom by a point on a ball surface (sphere). Since the plane integral Rₙƒ is invariant under reflection or spatial inversion, the totality of the relevant rotational positions can be represented by a hemispherical surface (hemisphere). That is, a detection of the additional rotational positions on the lower hemisphere is already covered by the opposite sign in the displacement s.

Since the plane integral Rₙƒ is invariant under rotation about the normal vector n of the three-dimensional Radon transform Rₙ, a rotation in the sense of conventional computed tomography does not offer any additional information for the inversion of the spatial Radon transform. In particular, up to a maximum of one detected rotational position, the fast second axis of rotation 114 should not therefore coincide with the normal vector n of the three-dimensional Radon transform Rₙ.

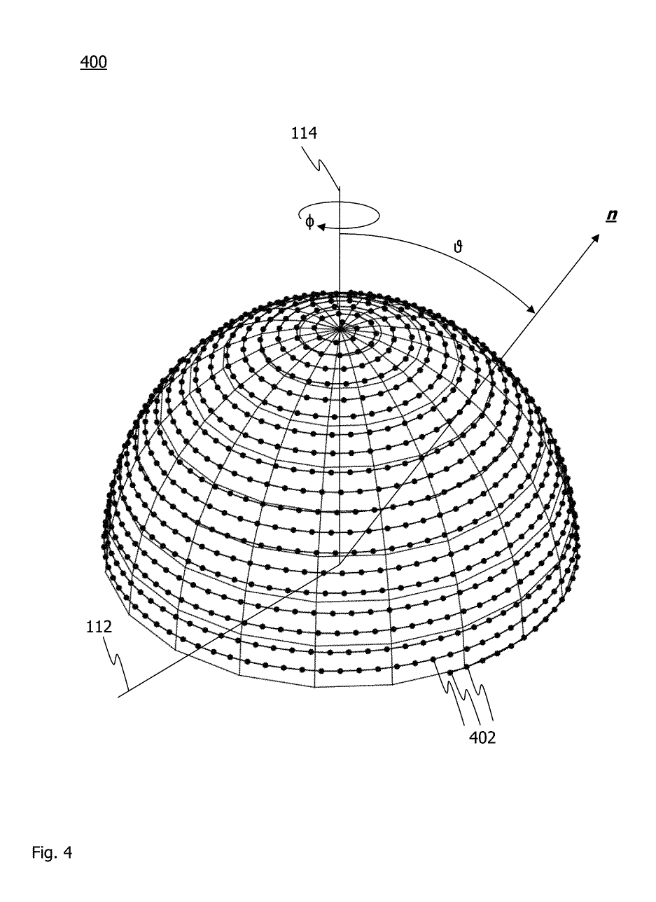

The orientation of the hemisphere in the reference system of the sample or the sample holder 104 can generally be selected freely. FIG. 4 shows a scheme 400 for sampling of the rotational positions 402 in the reference system of the sample or of the sample holder 104. The (standardised as unit vector) normal vector n of the three-dimensional Radon transform indicates the momentary rotational position in the reference system shown in FIG. 4.

Just as the sample or the sample holder 104 is rotated about the two axes 112 and 114 in the exemplary embodiments shown in FIGS. 1 to 3, the radiation source 102 and the detector 106 can also be rotated about the sample or the sample holder 104. In the latter case, the sampling scheme 400 can be implemented in a spatially fixed reference system.

Furthermore, as well as absorption contrast and phase contrast, all other observables ƒ(x) can be the basis of the dataset S(s), which can be detected at least approximately as plane integral [Rₙƒ](s). For example, fluorescence, small-angle scattering and wide-angle scattering contributions can be detected.

The plane integral Rₙƒ can be formed iteratively, for example as an integral determined by the arrangement over the propagation direction z of the beam and as an integral determined by the detector in the direction of the lines 118. Furthermore, grid tomography measurements are possible with the anisotropic radiation source 102.

The radiation can comprise any radiation interacting with the material to be analysed, for example X-ray photons, electrons and/or neutrons. A wave-optical evaluation of the detected signal is possible in the context of phase contrast. The detector or the evaluation unit can be embodied to detect the wave-optical phases of the beam by numerical reconstruction.

To express the dependence of the normal vector n on the rotational position (ϑ, ϕ) in the reference system of the sample or of the sample holder 104, the rotational position θ=(ϑ, ϕ) is written as an index of the normal vector n below.

For each rotational position, n=n_{θ}, and for each plane 116, s=sⱼ, the detector 106 detects a signal. The complete dataset S(n_{θ}, sⱼ) formed therefrom is the measured data of the tomographic image capture.

The evaluation of the measured data can be implemented in the detector 106 or in an evaluation unit connected to the detector 106 for data exchange (at least indirectly or periodically).

The evaluation can take place by means of Fourier transform with use of the Fourier slice theorem. Furthermore, the evaluation can take place by filtering following the backprojection (filtered plane recording or “filtered layergram”). Alternatively the evaluation can take place by filtering before the backprojection (filtered backprojection).

The backprojection can be implemented by the following operator R^{#} (which does not represent the inversion of the Radon transform):

( [symbol] ^{#}g)(x):=∫ds∫dn_{θ}δ(xn_{θ}−s)g(n_{θ},s),

wherein the integration takes place over the unit vector n_{θ} representing the rotational position and the displacement s of the planes 116. (Therein the function g is an arbitrary placeholder function for defining the operator R^{#}.)

The filtering can take place by means of the Riesz operator I⁰, which is defined by

[symbol]

(I^{α}ƒ)(x)=|x|^{-α}( [symbol] ƒ)(x),

wherein F is the n-dimensional Fourier transform (here n=3). I⁰ is thus the neutral element and I⁰ is the inverse element to I⁰. (Therein the function ƒ of the space with space points x is an arbitrary placeholder function for defining the operator I.)

The parameter α<n is freely selectable. For example, various exemplary embodiments of the evaluation can implement various parameters a.

In the following, ƒ(x) describes the property of the sample that is to be detected tomographically, and is thus image-capturing. From the measured complete dataset [Rnf](s)=S(n_{θ},sⱼ) the tomographic image ƒ(x) can be reconstructed by means of the backprojection R^{#} and the Riesz filtering I⁰, for example according to

$$f ( \underline{x} ) = \frac{1}{2} {( 2 π )}^{- n + 1} ( {I}^{- α} {\#}^{} {I}^{α + 1 - n} f ) ( \underline{x} ) .$$

A first exemplary embodiment of the evaluation is based on α=0 and produces a filtered backprojection,

$$f ( \underline{x} ) = \frac{1}{2} {( 2 π )}^{- n + 1} ( {\#}^{} {I}^{1 - n} f ) ( \underline{x} ) .$$

Since the dimension n of the Radon transform is odd, the Riesz filter can be implemented for the filtered backprojection as a local operator, namely a differentiation.

On the other hand, in conventional computed tomography (with n=2) the Riesz filter is non-local. Since the dataset is finite, artifacts due to edges and angles of the de-

The evaluation of the complete dataset Rf takes place, for example, according to

$$f ( \underline{x} ) = {i}^{n - 1} \frac{1}{2} {( 2 \frac{1}{\sqrt{2 π}} )}^{- n + 1} ( {\#}^{} {( \frac{\partial }{\partial s} )}^{n - 1} ( f ) ) ( \underline{x} ) .$$

A second exemplary embodiment of the evaluation is based on α=n−1 and produces a filtered plane recording,

$$f ( \underline{x} ) = \frac{1}{2} {( 2 π )}^{- n + 1} ( {I}^{n - 1} {\#}^{} f ) ( \underline{x} ) .$$

The Riesz filter can also be implemented as local differentiation in the second exemplary embodiment of the evaluation, in contrast to conventional computed tomography. The evaluation of the complete dataset Rf is carried out for example according to

$$f ( \underline{x} ) = \frac{1}{2} {( 2 π )}^{- n + 1} ( Δ {\#}^{} f ) ( \underline{x} ) .$$

Each exemplary embodiment of the evaluation can be implemented in each exemplary embodiment of the device 100.

Possible applications of the technique lie in analytical computed tomography. Applications in clinical computed tomography are likewise possible, for example by rotating the radiation source 102 and the detector 106 around a static patient. The geometrical conditions shown in FIG. 3 (a) for the distances z₁ and z₂ can be adhered to, for example by detecting a correspondingly small volume of the body.

As illustrated on the basis of the present exemplary embodiments, the technique makes it possible to utilise the source fluence of a radiation source more efficiently, for example because an anisotropy of the radiation source does not have to be blocked out, but can contribute to the tomographic image capture.

Due to the use of anisotropic and bright radiation sources, the technique can make possible applications (for instance as laboratory instruments) that could only be executed hitherto with synchrotron radiation.

Furthermore, the retransformation of the Radon transform for odd dimensionality has advantageous local properties, so that the reconstruction at any object point is determined only by the object function and its derivations. This is advantageous e.g. for local tomography (often described as region-of-interest tomography). Thus a subregion of the sample can be detected and reconstructed with higher resolution than would be necessary for the entire sample or possible on account of its size. The normal two-dimensional Radon transform (2dRT), on which conventional X-ray tomography is based, leads to non-local inversion operators and often shows (object-dependent) artifacts, in particular in local tomography.

Alternatively or in addition, the evaluation of the complete dataset (for example without using an inversion of the Radon transform) can take place by adapting any evaluation method known for computed tomography. For example, the (preferably isotropic) voxels of the tomographic imaging can be determined by regression methods and/or entropy maximisation methods.

Furthermore, an optional resolution of the detector 106 in the direction of the second transverse dimension can be included in any evaluation method (for example with or without inversion of the Radon transform) as additional information. Due to the increased information content, a spatial resolution of the reconstruction, for example, can be increased.

Exemplary embodiments can reduce or avoid a limitation of the image resolution due to dimensions of the radiation source such as occur in conventional tomography. Thus exemplary embodiments can achieve a resolution by means of the three-dimensional Radon transform that is finer than the expansion of the radiation source in a transverse direction of the beam. For image capturing with phase contrast the radiation source also only has to be restricted in one transverse dimension to guarantee a sufficiently high partial coherence.

The technique is thus compatible with a plurality of available, highly anisotropic radiation sources in such a way that due to the greater expansion in one direction, the effective fluence or intensity of the beam rises without the resolution falling.

1. Device (100) for tomographic image capturing, comprising:
a radiation source (102), which is embodied to emit a beam, wherein the radiation source (102) has a first transverse dimension (108) across the beam and a second transverse dimension (110) substantially perpendicular to the first transverse dimension (108), wherein the second transverse dimension (110) is greater than the first transverse dimension (108);
a detector (106), which is embodied to detect the beam; and
a sample holder (104) arranged between radiation source (102) and detector (106) which is embodied to rotate a sample in the beam about a first axis (112) and about a second axis (114) which differs from the first axis (112).

2. Device according to claim 1, wherein the second transverse dimension (110) is more than twice as great as the first transverse dimension (108).

3. Device according to claim 1 or 2, wherein the first axis (112) is substantially perpendicular to the second axis (114) and/or substantially parallel to the beam.

4. Device according to any one of claims 1 to 3, wherein the second axis (110) is substantially perpendicular to the beam.

5. Device according to any one of claims 1 to 4, further comprising a controller, which is embodied to rotate the sample by means of the sample holder (104) jointly about the first axis (112) and the second axis (114) for tomographic image capturing.

6. Device according to claim 5, wherein the sample is rotated repeatedly about the second axis while the second axis (114) tilts about the first axis (112).

7. Device according to claim 5 or 6, wherein the second axis (114) tilts substantially by 90° about the first axis (112).

8. Device according to any one of claims 5 to 7, wherein the controller is embodied for the tomographic image capturing to detect the beam by means of the detector (106) in a plurality of rotational positions with a rotation angle ϑ about the first axis (112) and a rotation angle ϕ about the second axis (114), wherein a linear relationship exists optionally for the plurality of rotational positions between cos ϑ and ϕ.

9. Device according to any one of claims 1 to 8, wherein the detector (106) and/or an evaluation unit connected to the detector (106) is embodied to detect the beam in the direction of the second transverse dimension (110) unresolved.

10. Device according to any one of claims 1 to 9, wherein the detector (106) and/or an evaluation unit connected to the detector (106) is embodied to detect the beam in the direction of the first transverse dimension resolved.

11. Device according to any one of claims 1 to 10, wherein the detector (106) is embodied to detect an intensity and/or a phase of the beam and/or an evaluation unit connected to the detector (106) is embodied to reconstruct the intensity and/or the phase of the beam.

12. Device according to any one of claims 9 to 11, wherein the detector (106) and/or is the evaluation unit is further embodied to invert a three-dimensional Radon transform, wherein planes of the three-dimensional Radon transform are substantially parallel
(a) to the second transverse dimension, and/or
(b) to the beam.

13. Device according to claim 12, wherein the detector (106) and/or the evaluation unit is further embodied to invert the three-dimensional Radon transform by means of a local filter.

14. Device according to any one of claims 1 to 13, wherein the emitted beam comprises electromagnetic radiation, optionally X-ray radiation.

15. Device according to any one of claims 1 to 14, wherein a linear dimension of a sample that can be taken up in the sample holder is smaller by a multiple than
(a) a distance (z₁) between the radiation source (102) and a centre of the sample holder (104) or of the sample, and/or
(b) a distance (z₂) between detector (106) and the centre of the sample holder (104) or of the sample.
